(19) United States
(12) Patent Application Publication
(10) Pub. No.: US 2026/0221115 A1
(43) Pub. Date: Jul. 30, 2026

(54) ELECTRO-OPTICAL DEVICE AND ELECTRONIC APPARATUS

(71) Applicant: SEIKO EPSON CORPORATION, Tokyo (JP)

(72) Inventors: Yuki YASHIRO, CHITOSE-SHI (JP); Masahito YOSHII, CHITOSE-SHI (JP)

(73) Assignee: SEIKO EPSON CORPORATION, Tokyo (JP)

(21) Appl. No.: 19/461,734

(22) Filed: Jan. 28, 2026

(30) Foreign Application Priority Data
Jan. 30, 2025 (JP) 2025-013732

(51) Int. Cl. G09G 3/36; G02F 1/1335; G02F 1/1362

(52) U.S. Cl. CPC G09G 3/3688; G02F 1/133512; G02F 1/136286; G09G 3/3607; G09G 2310/027

(57) ABSTRACT

An electro-optical device includes a plurality of data lines grouped every k lines, k being an integer of 2 or more, a data signal line to which a data signal according to gray levels of pixels is output for a group of every k lines, a transmission gate provided to correspond to each of the plurality of data lines, and a NOT circuit provided to correspond to the transmission gate and configured to supply a selection signal to a gate node of the transmission gate, wherein a conduction state between an input terminal and an output terminal of the transmission gate is specified based on the selection signal, the NOT circuit includes a P-channel type transistor and an N-channel type transistor coupled in series, and a channel length of the N-channel type transistor and a channel length of the P-channel type transistor are different from each other.

The present application is based on, and claims priority from JP Application Serial Number 2025-013732, filed January 30, 2025, the disclosure of which is hereby incorporated by reference herein in its entirety.

### BACKGROUND

### 1. Technical Field

The present disclosure relates to an electro-optical device and an electronic apparatus.

### 2. Related Art

An electronic apparatus such as a projector uses, for example, an electro-optical device such as a liquid crystal display device capable of changing optical characteristics pixel by pixel.

JP-A-2021-140056 discloses an electro-optical device of a demultiplexer type. In the device, data lines are divided into blocks for each of a plurality of columns, and a data signal supplied from a data signal line provided to correspond to each block is distributed to each data line by a transmission gate.

JP-A-2021-140056 is an example of the related art.

In the related art, a NOT circuit that logically inverts a selection signal input to a transmission gate is generally provided outside a panel. For example, there is a demand for mounting the NOT circuit in the panel in order to reduce the circuit size outside the panel. When the NOT circuit is mounted in the panel, it is desired to provide the NOT circuit so as to suppress an increase in panel temperature due to an increase in current consumption of the panel.

### SUMMARY

An electro-optical device according to an aspect of the present disclosure includes a plurality of data lines grouped every k lines, k being an integer of 2 or more, a data signal line to which a data signal according to gray levels of pixels is output for a group of every k lines, a transmission gate provided to correspond to each of the plurality of data lines, and a NOT circuit provided to correspond to the transmission gate and configured to supply a selection signal to a gate node of the transmission gate, wherein a conduction state between an input terminal and an output terminal of the transmission gate is specified based on the selection signal, the NOT circuit includes a P-channel type transistor and an N-channel type transistor coupled in series, and a channel length of the N-channel type transistor and a channel length of the P-channel type transistor are different from each other.

An electronic apparatus according to an aspect of the present disclosure includes the electro-optical device described above and a controller that controls an operation of the electro-optical device.

### BRIEF DESCRIPTION OF THE DRAWINGS

FIG. 1 is a perspective view showing a configuration of a module 1 including an electro-optical device according to a first embodiment.

FIG. 2 is a block diagram showing an electrical configuration of the module shown in FIG. 1.

FIG. 3 shows equivalent circuits of pixel circuits shown in FIG. 2.

FIG. 4 is a plan view showing an arrangement of transmission gates and NOT circuits shown in FIG. 2.

FIG. 5 shows a NOT circuit of a comparative example.

FIG. 6 shows a NOT circuit of the embodiment.

FIG. 7 shows a circuit diagram of the NOT circuit and a flow-through current of the comparative example.

FIG. 8 shows a circuit diagram of the NOT circuit and a flow-through current of the present embodiment.

FIG. 9 is a cross-sectional view of an N-channel type transistor provided in the NOT circuit shown in FIG. 5.

FIG. 10 is a cross-sectional view of an N-channel type transistor provided in the NOT circuit shown in FIG. 5.

FIG. 11 shows a planar arrangement of the NOT circuit and a light-shielding film shown in FIG. 5.

FIG. 12 is a plan view showing a NOT circuit of a first modification.

FIG. 13 is a cross-sectional view of an N-channel type transistor provided in a NOT circuit in a second modification.

FIG. 14 is a plan view of the N-channel type transistor and a light-shielding film in FIG. 13.

FIG. 15 is a plan view showing an arrangement of NOT circuits of a third modification.

FIG. 16 is a perspective view showing a personal computer as an example of an electronic apparatus.

FIG. 17 is a plan view showing a smartphone as an example of the electronic apparatus.

FIG. 18 is a schematic diagram showing a projector as an example of the electronic apparatus.

### DESCRIPTION OF EMBODIMENTS

A preferred embodiment according to the present disclosure will hereinafter be described with reference to the accompanying drawings. Note that in the drawings, dimensions and scales of components are different from the actual ones as appropriate and some portions are schematically illustrated in order to facilitate understanding. Furthermore, the scope of the present disclosure is not limited to the embodiment unless the present disclosure is not particularly limited in the following description.

### 1. Electro-optical device

### A. First Embodiment

### A-1. Basic Configuration

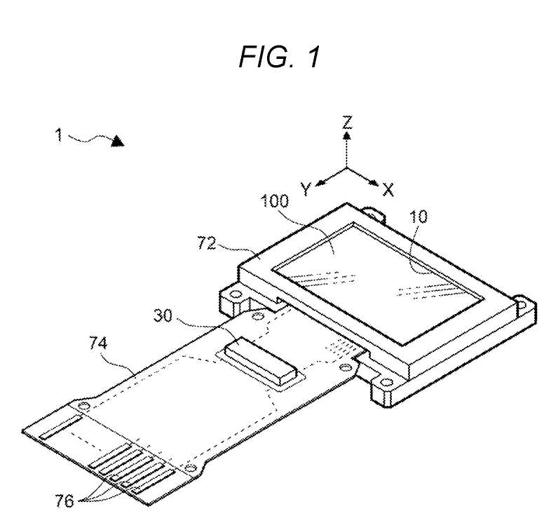

FIG. 1 is a perspective view showing a configuration of a module 1 including an electro-optical device 100 according to a first embodiment. The following description will be made by using an X axis, a Y axis, and a Z axis orthogonal to one another as appropriate for convenience of description.

FIG. 1 is the perspective view showing the configuration of the module 1 including the electro-optical device 100 according to the first embodiment. The module 1 includes the electro-optical device 100, a display control circuit 30, a case 72, and an FPC board 74. Note that FPC is an abbreviation for Flexible Printed Circuits.

The electro-optical device 100 is, for example, a transmissive liquid crystal panel used as a light valve of a projection-type display apparatus. The electro-optical device 100 is housed in the case 72. The case 72 has a frame shape open in a rectangular display region 10. One end of the FPC board 74 is coupled to the electro-optical device 100. A plurality of terminals 76 are provided at the other end of the FPC board 74, and are coupled to an upper circuit (not illustrated).

The display control circuit 30 is mounted on the FPC board 74 by face-down bonding, and video data is supplied from the upper circuit via the plurality of terminals 76 in synchronization with a synchronizing signal. The video data specifies the gray levels of pixels in an image to be displayed by, for example, 8 bits. The synchronizing signal includes a vertical synchronizing signal for instructing the pixel circuits arranged in the display region 10 to start vertical scanning, a horizontal synchronizing signal for instructing the pixels to start horizontal scanning, and a clock signal indicating the timing of video data for one pixel.

The display control circuit 30 is, for example, a semiconductor chip. The display control circuit 30 processes the video data and the synchronizing signal and outputs a data signal Vid and a control signal necessary for driving the electro-optical device 100. The data signal Vid is a signal obtained by converting the video data into an analog signal. The data signal Vid is a signal corresponding to the gray levels of the pixels. The control signal is a signal for controlling vertical scanning and horizontal scanning in the electro-optical device 100. Note that the display control circuit 30 may not be mounted on the FPC board 74, but may be provided in the upper circuit, and a video signal and the control signal may be supplied via the terminals 76.

When the electro-optical device 100 is used as a light valve of the projection-type display apparatus, as will be described later, transmission images by three electro-optical devices 100 corresponding to primary colors of R (red), G (green), and B (blue) are synthesized to represent a color image. Therefore, the pixel as a minimum unit of the color image is represented by additive color mixing by a red sub-pixel by the electro-optical device corresponding to R, a green sub-pixel by the electro-optical device corresponding to G, and a blue sub-pixel by the electro-optical device corresponding to B. However, when it is not necessary to specify the colors of the sub-pixels of red, green, and blue or when only light and dark matter, the expression as sub-pixels is not necessary. Accordingly, in this description, the sub-pixels of red, green, and blue are also simply described as "pixels".

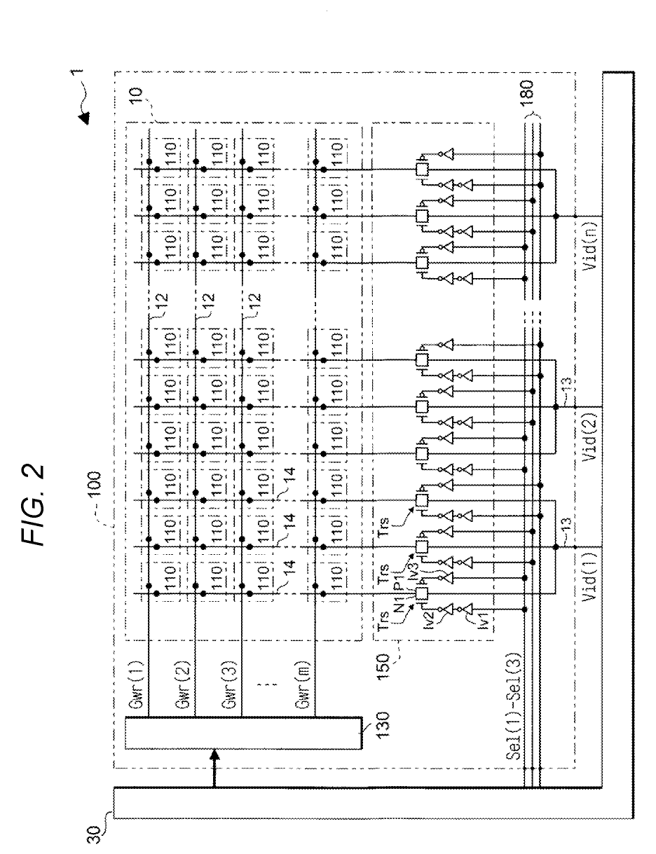

FIG. 2 is a block diagram showing an electrical configuration of the module 1 shown in FIG. 1. A scanning line drive circuit 130 and a data line drive circuit 150 as a peripheral circuit are provided on the periphery of the display region 10 in the electro-optical device 100 of the module 1.

The electro-optical device 100 has a configuration in which liquid crystal is sealed by an element substrate on which thin film transistors and the like are formed and a counter substrate on which a common electrode is formed. The scanning line drive circuit 130 and the data line drive circuit 150 are provided on the element substrate.

In the display region 10 of the electro-optical device 100, pixel circuits 110 corresponding to the pixels of the image to be displayed are arranged in a matrix. Specifically, the display region 10 is provided with a plurality of scanning lines 12 and a plurality of data lines 14 grouped every k lines, which is an integer of 2 or more. In the illustrated example, the plurality of scanning lines 12 are m scanning lines 12. The n data lines 14 grouped every k lines are 3n data lines 14 grouped every three lines. Note that m is an integer of 2 or more. n is an integer of 2 or more, and n is 3 in the present embodiment. Each of the m scanning lines 12 is provided to extend in the horizontal direction in FIG. 2. Each of the 3n data lines 14 is provided to extend in the vertical direction in FIG. 2. Each of the data lines 14 is electrically isolated from each of the scanning lines 12. The pixel circuits 110 are provided to correspond to the intersections of the m scanning lines 12 and the 3n data lines 14. Therefore, in the present embodiment, the pixel circuits 110 are arranged in a matrix of vertical m rows × horizontal 3n columns.

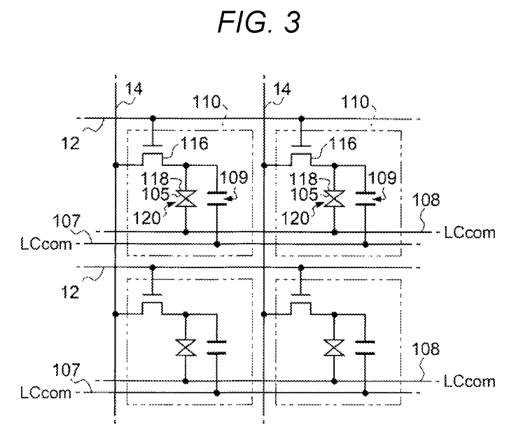

FIG. 3 shows equivalent circuits of the pixel circuits 110 shown in FIG. 2. FIG. 3 illustrates a total of four of 2 × 2 pixel circuits 110 corresponding to the intersections of the two adjacent scanning lines 12 and the two adjacent data lines 14.

As illustrated in FIG. 3, the pixel circuit 110 includes a transistor 116 and a liquid crystal element 120. The transistor 116 is, for example, an N-channel type thin film transistor. In the pixel circuit 110, the gate node of the transistor 116 is coupled to the scanning line 12, the source node thereof is coupled to the data line 14, and the drain node thereof is coupled to a pixel electrode 118.

In the present description, "coupling" means direct or indirect coupling or joining between two or more elements, and includes, for example, joining between two or more elements not directly via another element.

A common electrode 108 is provided in common to all pixels on the counter substrate so as to face the pixel electrodes 118. The common electrode 108 is maintained at a temporally substantially constant potential LCcom. Liquid crystal 105 is sandwiched between the pixel electrode 118 and the common electrode 108. Therefore, for each pixel circuit 110, the pixel electrode 118, the common electrode 108, and the liquid crystal 105 form the liquid crystal element 120.

A storage capacitor 109 is provided electrically in parallel with the liquid crystal element 120. In the storage capacitor 109, one end is coupled to the pixel electrode 118, and the other end is coupled to a capacitance line 107. The capacitance line 107 is maintained at a temporally constant potential, for example, the same potential LCcom as that of the common electrode 108.

The display control circuit 30 illustrated in FIG. 2 processes the video data and the synchronizing signal supplied from the upper circuit, and outputs data signals Vid(1), Vid(2),..., Vid(n) and selection signals Sel(1) to Sel(3) to the data line drive circuit 150 in addition to the control signal to the scanning line drive circuit 130. When the data signals Vid(1), Vid(2),..., Vid(n) are not distinguished, the signals are referred to as data signals Vid. The data signal Vid is horizontally scanned on three data lines 14 belonging to one group. The data signal Vid is a signal that supplies potentials corresponding to the gray levels of the three pixels corresponding to the intersection with the scanning line 12 in a time division manner in a horizontal scanning period.

Furthermore, one of the three data lines 14 belonging to one group is referred to as a first data line 14a, another one data line 14 is referred to as a second data line 14b, and the remaining one data line 14 is referred to as a third data line 14c. For example, the first data line 14a, the second data line 14b, and the third data line 14c are arranged from the left side to the right side in the drawing in each group.

The scanning line drive circuit 130 individually supplies scanning signals GWr to the m rows of scanning lines 12 under the control of the display control circuit 30. Specifically, the scanning signal supplied to the scanning line 12 in the first row is denoted by Gwr(1), and the scanning signals supplied to the scanning lines 12 in the second, third,..., m-th rows are sequentially denoted by Gwr(2), Gwr(3),..., Gwr(m).

The data line drive circuit 150 is a circuit that distributes the data signals Vid to the data lines 14 according to selection signals Sel(1) to Sel(3). The selection signal Sel(1) is a signal for selecting the first data line 14a. Similarly, the selection signal Sel(2) is a signal for selecting the second data line 14b, and the selection signal Sel(3) is a signal for selecting the third data line 14c.

The data line drive circuit 150 includes a transmission gate Trs and NOT circuits Iv1, Iv2, and Iv3 for each column of the data lines 14. Therefore, the transmission gate Trs and the NOT circuits Iv1, Iv2, and Iv3 are provided to correspond to each of the plurality of data lines 14. In addition, a plurality of data signal lines 13 are provided in the electro-optical device 100. The data signal line 13 outputs the data signal Vid corresponding to a group of 3n data lines 14.

The transmission gate Trs is an analog switch in which a P-channel type transistor P1 and an N-channel type transistor N1 are coupled in parallel. The transistors P1 and N1 are thin film transistors similar to the transistor 116 in the pixel circuit 110. The conduction state between the input terminal and the output terminal of the transmission gate Trs is specified based on Sel(1) to Sel(3).

In the transmission gate Trs corresponding to the first data line 14a, the input terminal is coupled to the data signal line 13 corresponding to the group to which the first data line 14a belongs, and the output terminal is coupled to the first data line 14a. Similarly, in the transmission gate Trs corresponding to the second data line 14b, the input terminal is coupled to the data signal line 13 corresponding to the group to which the second data line 14b belongs, and the output terminal is coupled to the second data line 14b. In the transmission gate Trs corresponding to the third data line 14c, the input terminal is coupled to the data signal line 13 corresponding to the group to which the third data line 14c belongs, and the output terminal is coupled to the third data line 14c. In other words, the input terminals of the transmission gates Trs corresponding to the three data lines 14 belonging to one group are commonly coupled to one data signal line 13. The output terminal of the transmission gate Trs is coupled to the corresponding data line 14.

Each of the NOT circuits Iv1, Iv2, and Iv3 is an inverter that inverts the logic level of a signal and outputs the inverted signal. The NOT circuits Iv1, Iv2, and Iv3 are provided to supply the selection signals Sel(1) to Sel(3) to the gate node of the transmission gate Trs.

The NOT circuit Iv1 corresponding to the first data line 14a inverts and outputs the logic level of the selection signal Sel(1), and the NOT circuit Iv2 re-inverts and outputs the logic level of the inverted signal by the NOT circuit Iv1. That is, the NOT circuits Iv1 and Iv2 corresponding to the first data line 14a are buffer circuits that buffer the logic level of the selection signal Sel(1). The NOT circuit Iv2 corresponding to the first data line 14a supplies the buffered selection signal Sel(1) to the gate node of the transistor N1 in the transmission gate Trs of the first data line 14a. The NOT circuit Iv3 corresponding to the first data line 14a inverts the logic level of the selection signal Sel(1) and supplies the inverted signal to the gate node of the transistor P1 in the transmission gate Trs corresponding to the first data line 14a.

The same applies to the NOT circuits Iv1 and Iv2 corresponding to the second data line 14b, and the selection signal Sel(2) is buffered and supplied to the gate node of the transistor N1 in the transmission gate Trs corresponding to the second data line 14b. Similarly, the NOT circuit Iv3 corresponding to the second data line 14b inverts the logic level of the selection signal Sel(2) and supplies the inverted signal to the gate node of the transistor P1 in the transmission gate Trs corresponding to the second data line 14b.

The same applies to the NOT circuits Iv1 and Iv2 corresponding to the third data line 14c, and the selection signal Sel(3) is buffered and supplied to the gate node of the transistor N1 in the transmission gate Trs corresponding to the third data line 14c. Similarly, the NOT circuit Iv3 corresponding to the third data line 14c inverts the logic level of the selection signal Sel(3) and supplies the inverted signal to the gate node of the transistor P1 in the transmission gate Trs corresponding to the third data line 14c.

FIG. 2 is the block diagram showing the electrical configuration of the module 1 and, actually, the data line drive circuit 150 is provided, for example, between one end of the FPC substrate 74 and the display region 10. In addition, for example, two scanning line drive circuits 130 may be provided so as to sandwich the display region 10 on the Y axis in order to suppress the influence on the display due to the delay of the scanning signal.

In the electro-optical device 100, the m rows of scanning lines 12 are scanned one by one in the order of first, second, third,..., m-th rows. Specifically, the levels of the scanning signals Gwr(1), Gwr(2), Gwr(3),..., Gwr(m) sequentially and exclusively become the H level for each horizontal scanning period by the scanning line drive circuit 130. When the level of the scanning signal Gwr becomes the H level, the transistor 116 of the pixel circuit 110 to which the scanning signal Gwr is supplied is turned on. Therefore, in the pixel circuit 110, one end of the liquid crystal element 120 and one end of the storage capacitor 109 are electrically coupled to the corresponding data line 14.

In the period in which the scanning signal Gwr is at the H level, the levels of the selection signals Sel(1), Sel(2), and Sel(3) sequentially and exclusively become the H level.

When the level of the selection signal Sel(1) becomes the H level, the level of the output of the NOT circuit Iv2 corresponding to the first data line 14a becomes the H level, and the level of the output of the NOT circuit Iv3 becomes the L level. Therefore, the transmission gate Trs corresponding to the first data line 14a is turned on. The display control circuit 30 sequentially outputs the potentials of the data signals Vid(1), Vid(2),..., and Vid(n) according to the gray levels of the pixels corresponding to the first data line 14a and according to the writing polarity. Therefore, the data signal Vid is applied to one end of the liquid crystal element 120 and one end of the storage capacitor 109 in the pixel circuit 110 corresponding to the first data line 14a via the first data line 14a. The potential of the data signal Vid applied to one end of the liquid crystal element 120 is held by the storage capacitor 109 even when the transmission gate Trs is turned off and the level of the scanning signal Gwr becomes the L level. Here, in the liquid crystal element 120, alignment of liquid crystal molecules changes according to an electric field generated by the pixel electrode 118 and the common electrode 108. Therefore, the liquid crystal element 120 has transmittance according to the effective value of an applied voltage. In the present embodiment, a normally black mode in which the transmittance is the lowest when the voltage applied to the liquid crystal element 120 is zero and the transmittance increases as the applied voltage increases is set.

Then, the level of the selection signal Sel(1) becomes the L level, and the level of the selection signal Sel(2) becomes the H level. When the level of the selection signal Sel(2) becomes the H level, the transmission gate Trs corresponding to the second data line 14b is turned on. The display control circuit 30 sequentially outputs the potentials of the data signals Vid(1), Vid(2),..., and Vid(n) according to the gray levels of the pixels corresponding to the second data line 14b and according to the writing polarity. Therefore, the liquid crystal element 120 of the pixel circuit 110 corresponding to the second data line 14b has transmittance according to the gray level.

Then, the level of the selection signal Sel(2) becomes the L level, and the level of the selection signal Sel(3) becomes the H level. When the level of the selection signal Sel(3) becomes the H level, the transmission gate Trs corresponding to the third data line 14c is turned on. The display control circuit 30 sequentially outputs the potentials of the data signals Vid(1), Vid(2),..., and Vid(n) according to the gray levels of the pixels corresponding to the third data line 14c and according to writing polarity. Therefore, the liquid crystal element 120 of the pixel circuit 110 corresponding to the third data line 14c has transmittance corresponding to the gray level.

In addition, as described above, in the embodiment, the element that writes the data signal Vid supplied to the data signal line 13 in the data line 14 includes the transmission gate Trs in which the transistors P1 and N1 are complementarily coupled in parallel. In the transmission gate Trs, since the transistors P1 and N1 are turned on at the same time, the on-resistance is substantially half compared to a configuration in which only one transistor is provided. In the transmission gate Trs, the transistor P1 compensates for insufficient writing of the transistor N1 when the data signal Vid has a positive potential at a high gray level. In contrast, the transistor N1 compensates for insufficient writing of the transistor P1 when the data signal Vid has a negative potential at a high gray level. Therefore, the display unevenness caused by a difference in polarity can be suppressed using the transmission gate Trs. As described above, in order to achieve high resolution, it is preferable that the switching element for writing the data signal Vid supplied to the data signal line 13 in the data line 14 is configured with the transmission gate Trs.

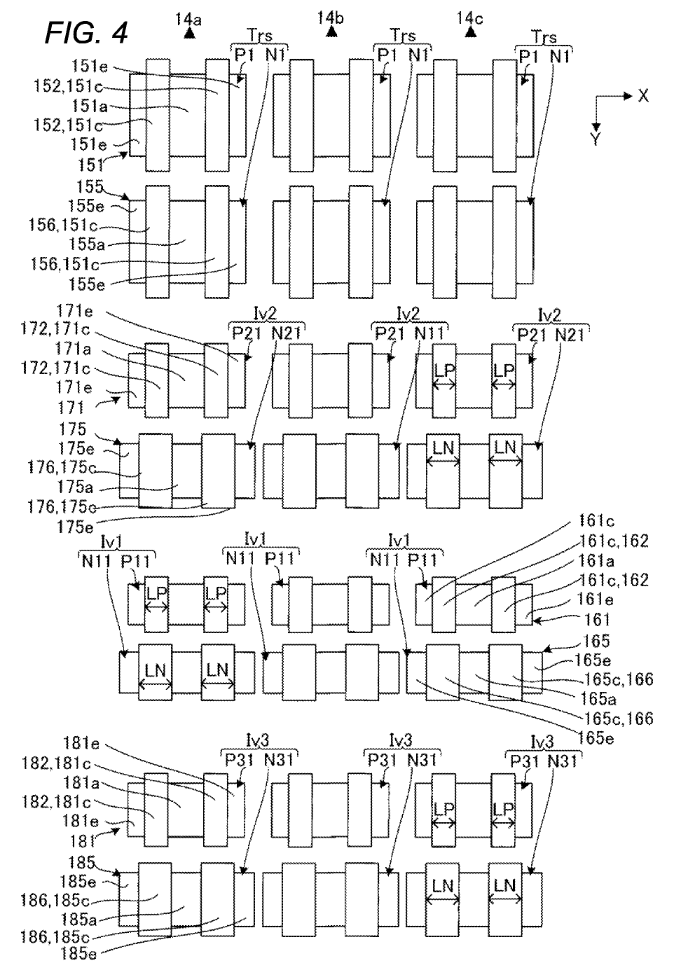

FIG. 4 is a plan view showing the arrangement of the transmission gates Trs and the NOT circuits Iv1, Iv2, and Iv3 shown in FIG. 2. In the example illustrated in FIG. 4, the NOT circuits Iv2, Iv1, and Iv3 are arranged in this order from the transmission gate Trs in the direction along the Y axis, which is the extension direction of the data line 14. The transmission gate Trs is closest to the display region 10. The transmission gates Trs and the NOT circuits Iv2, Iv1, and Iv3 are arranged along the corresponding data lines 14. The plurality of transmission gates Trs are arranged in the direction along the X axis, which is the direction in which the plurality of data lines 14 are arranged.

In FIG. 4, for example, the transmission gates Trs and the NOT circuits Iv2, Iv1, and Iv3 corresponding to the three data lines 14 belonging to the same group are illustrated. Therefore, the transmission gates Trs and the NOT circuits Iv2, Iv1, and Iv3 respectively corresponding to the first data line 14a, the second data line 14b, and the third data line 14c are illustrated.

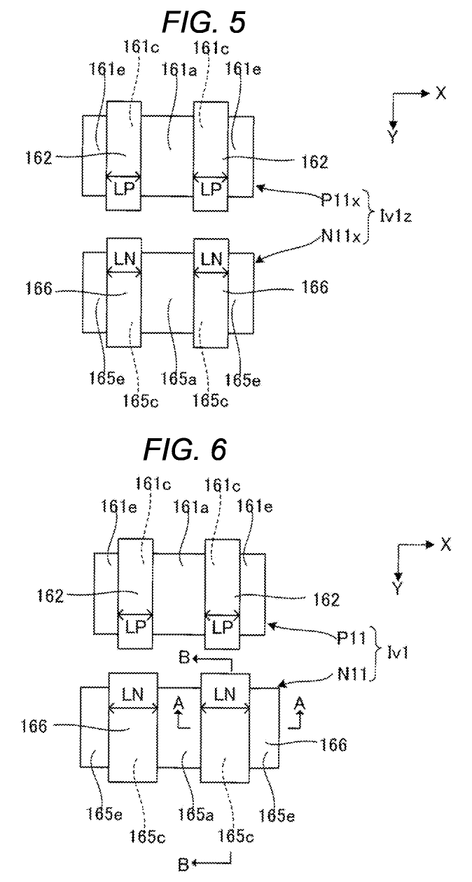

The transmission gate Trs includes transistors P1 and N1. The transistor P1 includes a semiconductor layer 151, a gate electrode 152, and a gate insulating film. The gate insulating film is disposed between the semiconductor layer 151 and the gate electrode 152, and is not illustrated in FIG. 5. The semiconductor layer 151 includes at least a source-drain region 151a, a channel region 151c, and a source-drain region 151e. The transistor P1 has a configuration in which two transistors are arranged in parallel. In the transistor P1, the source-drain region 151a is shared, and the source-drain regions 151e are independent. Note that the "source-drain region" is a region including either one of a source and a drain. Similarly, the transistor N1 includes a semiconductor layer 155, a gate electrode 156, and a gate insulating film. The semiconductor layer 155 includes a source-drain region 155a, a channel region 155c, and source-drain regions 155e. The transistor N1 has a configuration in which two transistors are arranged in parallel.

The NOT circuit Iv1 has a configuration in which a P-channel type transistor P11 and an N-channel type transistor N11 are coupled in series between power supply voltages. The P-channel type transistor P11 includes a semiconductor layer 161, a gate electrode 162, and a gate insulating film. The semiconductor layer 161 includes at least a source-drain region 161a, a channel region 161c, and a source-drain region 161e. The P-channel type transistor P11 has a configuration in which two transistors are arranged in parallel. Similarly, the N-channel type transistor N11 includes a semiconductor layer 165, a gate electrode 166, and a gate insulating film. The semiconductor layer 165 includes a source-drain region 165a, a channel region 165c, and a source-drain region 165e. The N-channel type transistor N11 has a configuration in which two transistors are arranged in parallel.

Similarly, the NOT circuit Iv2 has a configuration in which a P-channel type transistor P21 and an N-channel type transistor N21 are coupled in series between power supply voltages. The P-channel type transistor P21 includes a semiconductor layer 171, a gate electrode 172, and a gate insulating film. The semiconductor layer 171 includes at least a source-drain region 171a, a channel region 171c, and a source-drain region 171e. The P-channel type transistor P21 has a configuration in which two transistors are arranged in parallel. Similarly, the N-channel type transistor N21 includes a semiconductor layer 175, a gate electrode 176, and a gate insulating film. The semiconductor layer 175 includes a source-drain region 175a, a channel region 175c, and a source-drain region 175e. The N-channel type transistor N21 has a configuration in which two transistors are arranged in parallel.

Similarly, the NOT circuit Iv3 has a configuration in which a P-channel type transistor P31 and an N-channel type transistor N31 are coupled in series between power supply voltages. The P-channel type transistor P31 includes a semiconductor layer 181, a gate electrode 182, and a gate insulating film. The semiconductor layer 181 includes at least a source-drain region 181a, a channel region 181c, and a source-drain region 181e. The P-channel type transistor P31 has a configuration in which two transistors are arranged in parallel. Similarly, the N-channel type transistor N31 includes a semiconductor layer 175, a gate electrode 176, and a gate insulating film. The semiconductor layer 175 includes a source-drain region 185a, a channel region 185c, and a source-drain region 185e. The N-channel type transistor N31 has a configuration in which two transistors are arranged in parallel.

FIG. 5 shows a NOT circuit Iv1x of a comparative example. As illustrated in FIG. 5, in the NOT circuit Iv1x of the comparative example, a channel length LP of an N-channel type transistor N11x and a channel length LN of an N-channel type transistor N11x are the same length. Each of the channel lengths LP and LN is a distance between the source and the drain, and is a parameter that affects the performance and operation of the transistor. As the channel length is shorter, the transistor can operate faster, but there is a disadvantage such as an increase in leakage current.

FIG. 6 shows the NOT circuit Iv1 of the present embodiment. As shown in FIG. 6, in the NOT circuit Iv1 of the present embodiment, a channel length LP of the P-channel type transistor P11 and a channel length LN of the N-channel type transistor N11 are different from each other. In the illustrated example, the channel length LN is longer than the channel length LP.

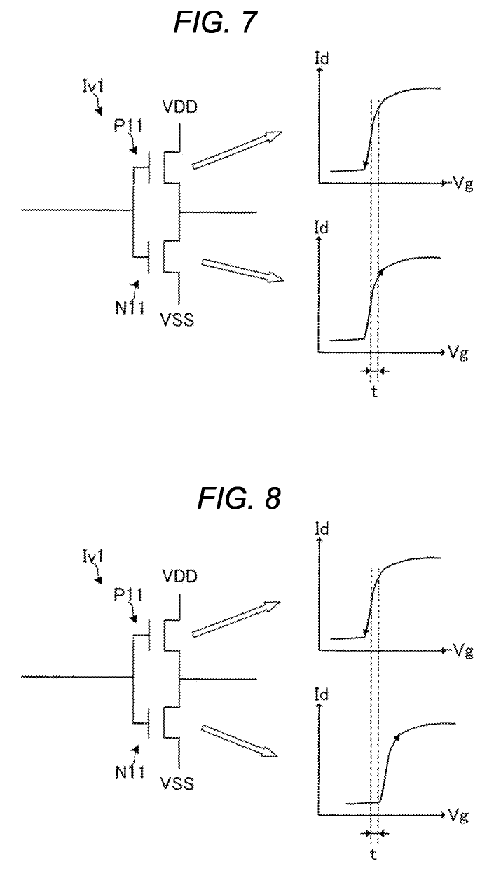

FIG. 7 shows a circuit diagram of the NOT circuit Iv1x and a flow-through current of the comparative example. FIG. 8 shows a circuit diagram of the NOT circuit Iv1 and a through current of the present embodiment. Each of FIGS. 7 and 8 shows a relationship between a gate voltage Vg and a drain current Id.

In the NOT circuit Iv1x of the comparative example, the channel length LN and the channel length LP are the same. Therefore, as illustrated in FIG. 7, in the NOT circuit Iv1x of the comparative example, the N-channel type transistor N11x and the P-channel type transistor P11x are simultaneously turned on, and the flow-through current which is a current flowing from a positive power supply voltage VDD side toward a negative power supply voltage VSS side is generated in a transition period t in which the transistors are turned on.

In contrast, in the NOT circuit Iv1 of the present embodiment, the channel length LN and the channel length L are different from each other. Therefore, as shown in FIG. 8, in the NOT circuit Iv1 of the present embodiment, the period in which the N-channel type transistor N11 is turned on can be shifted from a transition period t in which the P-channel type transistor P11 is turned on. Thus, the flow-through current can be significantly reduced.

As can be seen from FIGS. 7 and 8, in the present embodiment, since the channel length LN and the channel length LP are different from each other, the flow-through current can be significantly reduced as compared with the case where the channel lengths are the same. Therefore, according to the present embodiment, it is possible to suppress an increase in the temperature of the electro-optical device 100 due to an increase in the current consumption of the electro-optical device 100.

In the present embodiment, as shown in FIG. 6, the channel length LN is longer than the channel length LP. The N-channel type transistor N11 tends to have a higher writing capability. Therefore, even when the channel length LN is set to be longer than the channel length LP, the high-speed operation of the NOT circuit Iv1 is easily ensured.

The NOT circuit Iv1 has been described above, and the same applies to the NOT circuits Iv2 and Iv3. As shown in FIG. 4, the channel length LN and the channel length LP of each NOT circuit are different. Furthermore, the channel length LN is longer than the channel length LP.

In the present embodiment, the channel length LN and the channel length LP are different in all of the NOT circuits Iv1, Iv2, and Iv3, but the channel length LN and the channel length LP may be different in at least one of the NOT circuits Iv1, Iv2, and Iv3.

The NOT circuit Iv1 corresponding to the first data line 14a is referred to as a "first NOT circuit Iv1a". The NOT circuit Iv2 corresponding to the second data line 14b is referred to as a "second NOT circuit Iv2a". The P-channel type transistor P11 of the first NOT circuit Iv1a is referred to as a "first P-channel type transistor P11a", and the N-channel type transistor N11 of the first NOT circuit Iv1a is referred to as a "first N-channel type transistor N11a". The P-channel type transistor P21 of the second NOT circuit Iv2a is referred to as a "second P-channel type transistor P21a", and the N-channel type transistor N21 of the second NOT circuit Iv2a is referred to as a "second N-channel type transistor N21a".

The first P-channel type transistor P11a and the first N-channel type transistor N11a are arranged in the direction along the Y axis as the extension direction of the first data line 14a. The second P-channel type transistor P21a and the second N-channel type transistor N21a are arranged in the direction along the Y axis as the extension direction of the first data line 14a. The first P-channel type transistor P11a and the second P-channel type transistor P21a are arranged in the direction along the X axis. The first N-channel type transistor N11a and the second N-channel type transistor N21a are arranged in the direction along the X axis.

Since the P-channel type transistors P11 are arranged in the direction along the X-axis in which the plurality of data lines 14 are arranged, and the N-channel type transistors N11 are arranged in the direction along the X-axis in which the plurality of data lines 14 are arranged, the layout is easy.

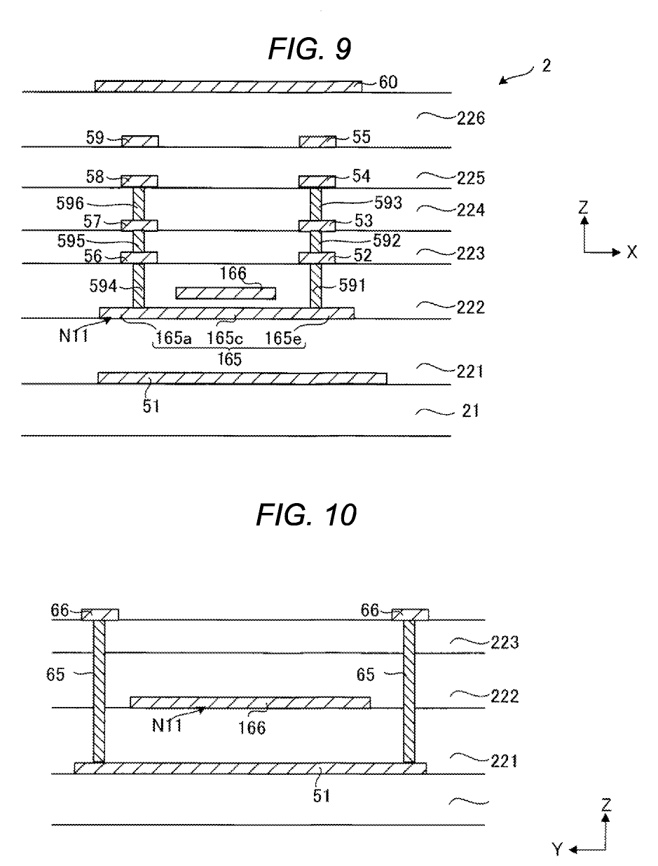

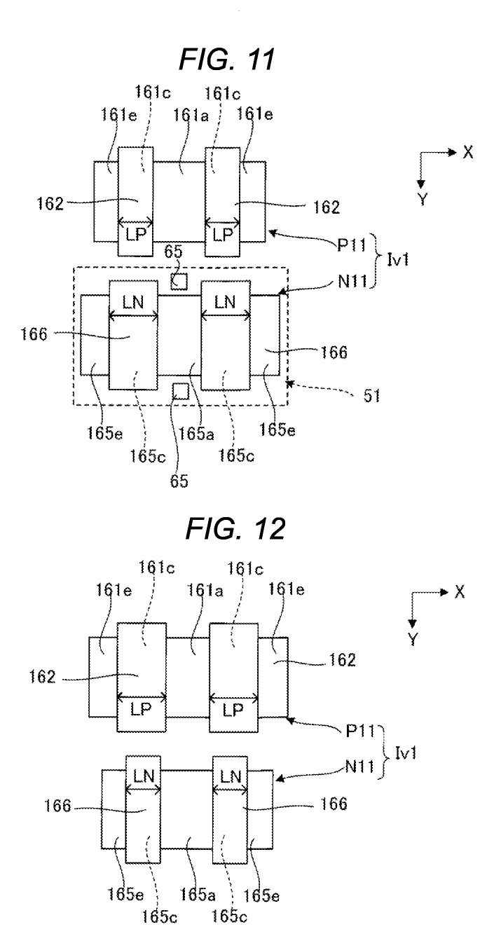

FIGS. 9 and 10 are cross-sectional views of the N-channel type transistor N11 of the NOT circuit Iv1 shown in FIG. 5. FIG. 11 shows a planar arrangement of the NOT circuit Iv1 and a light-shielding film 51 shown in FIG. 5. FIG. 9 corresponds to a cross section taken along line A-A in FIG. 6. FIG. 10 corresponds to a part of a cross section taken along line B-B in FIG. 6.

The N-channel type transistor N11 is illustrated in FIG. 9, and the P-channel type transistor P11 has the same configuration. Similarly, the P-channel type transistor P21 and the N-channel type transistor N21 of the NOT circuit Iv2 and the P-channel type transistor P31 and the N-channel type transistor N31 of the NOT circuit Iv3 have the same configuration as the P-channel type transistor P11 of the NOT circuit Iv1 illustrated in FIG. 9. Hereinafter, the P-channel type transistor P11 of the NOT circuit Iv1 will be described as a representative.

The NOT circuits Iv1, Iv2, and Iv3 are provided on an element substrate 2. The upper side of FIG. 9 is a liquid crystal side.

As illustrated in FIG. 9, the element substrate 2 includes a substrate 21 and insulating layers 221 to 226. The substrate 21 includes, for example, a glass substrate or a quartz substrate. Each of the insulating layers 221 to 226 contains an inorganic material including silicon such as silicon oxide or silicon oxynitride.

The light-shielding film 51 is provided on the substrate 21. The light-shielding film 51 is formed of, for example, a metal such as tungsten, aluminum, or titanium, an oxide of the metal, or a nitride of the metal.

The light-shielding film 51 is located below the N-channel type transistor N11. As illustrated in FIG. 11, the light-shielding film 51 overlaps the N-channel type transistor N11 in a plan view in the thickness direction of the substrate 21. The light-shielding film 51 has a light-shielding property and is provided to prevent light from entering the N-channel type transistor N11 from below. Therefore, it is possible to effectively suppress the occurrence of malfunction or the like of the N-channel type transistor N11.

In contrast, the light-shielding film 51 does not overlap the P-channel type transistor P11 in the plan view. In the present embodiment, the channel length LN of the N-channel type transistor N11 is longer than the channel length LP of the P-channel type transistor P11. The capability of the N-channel type transistor N11 having the longer channel length LN may deteriorate by increasing the channel length LN. Therefore, the reliability of the NOT circuit Iv1 can be increased by blocking the incidence of light on the N-channel type transistor N11.

In addition, the light-shielding film 51 may overlap the P-channel type transistor P11 in the plan view. However, since the light-shielding film 51 does not overlap the P-channel type transistor P11 in the plan view, the arrangement density of the light-shielding film 51 can be reduced. Therefore, it is possible to suppress the occurrence of warpage or the like of the substrate 21 due to the provision of the light-shielding film 51.

As illustrated in FIG. 9, the N-channel type transistor N11 is disposed on the insulating layer 221. The P-channel type transistors P11, P21, and P31 and the N-channel type transistors N21 and N31 are disposed in the same layer as that of the N-channel type transistor N11 and are provided at the same position in the direction along the Z axis. Relay electrodes 52 and 56 are disposed on the insulating layer 222. The relay electrode 52 is coupled to the source-drain region 155e via a contact 591 that penetrates the insulating layer 222. The relay electrode 56 is coupled to the source-drain region 155a via a contact 594 that penetrates the insulating layer 222. Relay electrodes 53 and 57 are disposed on the insulating layer 223. The relay electrode 53 is coupled to the relay electrode 52 via a contact 592 that penetrates the insulating layer 223. The relay electrode 57 is coupled to the relay electrode 56 via a contact 595 that penetrates the insulating layer 223.

Relay electrodes 54 and 58 are disposed on the insulating layer 224. The relay electrode 54 is coupled to the relay electrode 53 via a contact 593 that penetrates the insulating layer 224. The relay electrode 54 is electrically coupled to the data line 14 illustrated in FIG. 2. The relay electrode 57 is coupled to the relay electrode 56 via a contact 595 that penetrates the insulating layer 223. The relay electrode 57 is electrically coupled to the data signal line 13 illustrated in FIG. 2.

Relay electrodes 55 and 59 are disposed on the insulating layer 225. The relay electrode 55 is electrically coupled to the gate of the transistor P1 of the transmission gate Trs via various relay electrodes and contacts not illustrated in FIG. 9. The relay electrode 59 is electrically coupled to the gate of the transistor N1 of the transmission gate Trs via various relay electrodes and contacts not illustrated in FIG. 9.

A light-shielding layer 60 is disposed on the insulating layer 226. The light-shielding layer 60 may overlap one or both of the N-channel type transistor N11 and the P-channel type transistor P11 in the plan view.

As shown in FIG. 10, wires 66 are disposed on the insulating layer 223. The wires 66 are disposed above the N-channel type transistor N11. A constant potential is supplied to the wires 66. The wires 66 are coupled to the light-shielding film 51 via contacts 65. Therefore, a constant potential is supplied to the light-shielding film 51. For example, a potential LCcom, a GND potential, or a power supply potential is supplied to the light-shielding film 51. The contacts 65 are disposed in holes that penetrate the insulating layers 221 to 223. The wires 66 at a low potential and the light-shielding film 51 are electrically coupled by the contacts 65, so that the light-shielding film 51 is maintained at a constant potential.

The contacts 65 do not overlap the N-channel type transistor N11 in the plan view. The contacts 65 do not overlap the P-channel type transistor P11 in the plan view. The contacts 65 may be omitted. In this case, the light-shielding film 51 is floated.

### B. Modifications

The first embodiment can be variously modified. Specific configurations of modifications applicable to the first embodiment described above will be exemplified below. Two or more configurations randomly selected from the following examples can be combined as appropriate to the extent not contradictory with one another.

### B-1. First Modification

FIG. 12 is a plan view showing a NOT circuit Iv1 of a first modification. In the example illustrated in FIG. 12, the channel length LP is longer than the channel length LN. When the channel length LN is set to be longer as in the first embodiment, the capability of the N-channel type that is good at charging at a low potential may deteriorate, however, such a problem does not occur because the channel length LP is longer than the channel length LN.

### B-2. Second Modification

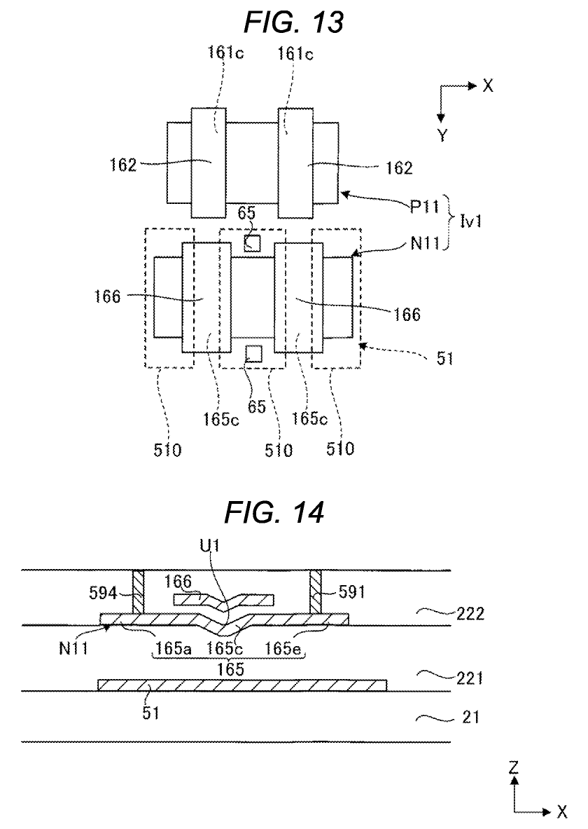

FIG. 13 is a cross-sectional view of an N-channel type transistor N11 of a NOT circuit Iv1 in a second modification. FIG. 14 is a plan view of the N-channel type transistor N11 and a light-shielding film 51 in FIG. 13.

As shown in FIGS. 13 and 14, in the present modification, the light-shielding film 51 is divided into a plurality of portions. Therefore, in the present modification, the light-shielding film 51 includes a plurality of light-shielding portions 510.

In the present modification, the light-shielding film 51 does not overlap a part of the channel region 165c in the plan view. Therefore, the upper surface of the insulating layer 221 on the light-shielding film 51 has irregularities depending on the presence or absence of the light-shielding film 51. Accordingly, the channel region 165c also has irregularities due to the influence of the irregularities. Specifically, a portion of the channel region 165c that does not overlap the light-shielding film 51 in the plan view is recessed toward the substrate 21. Therefore, the channel region 165c has a concave portion U1. The concave portion U1 is a part of the channel region 165c of the semiconductor layer 165. The gate electrode 166 also has a recess along the concave portion U1. By providing the concave portion U1, the channel length LN can be made substantially longer as compared with a case where the concave portion is not provided.

### B-3. Third Modification

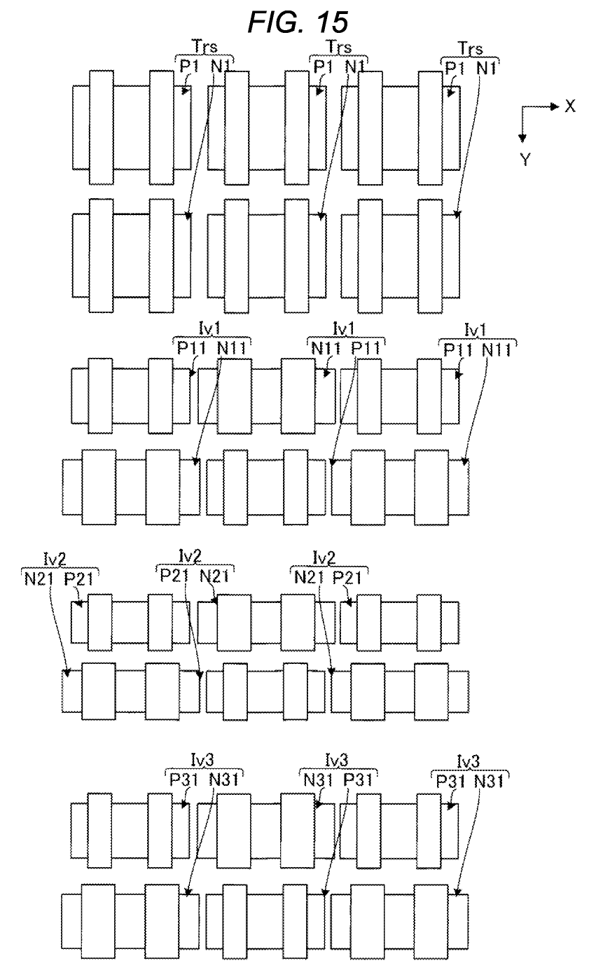

FIG. 15 is a plan view showing an arrangement of NOT circuits Iv1, Iv2, and Iv3 of a third modification. As described above, the NOT circuit Iv1 corresponding to the first data line 14a is referred to as a "first NOT circuit Iv1a". The NOT circuit Iv2 corresponding to the second data line 14b is referred to as a "second NOT circuit Iv2a". The P-channel type transistor P11 of the first NOT circuit Iv1a is referred to as a "first P-channel type transistor P11a", and the N-channel type transistor N11 of the first NOT circuit Iv1a is referred to as a "first N-channel type transistor N11a". The P-channel type transistor P21 of the second NOT circuit Iv2a is referred to as a "second P-channel type transistor P21a", and the N-channel type transistor N21 of the second NOT circuit Iv2a is referred to as a "second N-channel type transistor N21a".

The first P-channel type transistor P11a and the first N-channel type transistor N11a are arranged in the direction along the Y axis as the extension direction of the first data line 14a. The second P-channel type transistor P21a and the second N-channel type transistor N21a are arranged in the direction along the Y axis as the extension direction of the first data line 14a. The first P-channel type transistor P11a and the second N-channel type transistor N21a are arranged in the direction along the X axis. Therefore, the P-channel type transistor P11 and the N-channel type transistor N11 are alternately arranged in a row along the X axis as the direction in which the data lines 14 are arranged.

According to the arrangement, the clearance between a certain P-channel type transistor P11 and the N-channel type transistor N11 adjacent to the P-channel type transistor P11 in the direction along the X axis and the clearance between a certain N-channel type transistor N11 and the P-channel type transistor P11 adjacent to the N-channel type transistor N11 in the direction along the X axis can be set to the same value. Therefore, the pitch of the data lines 14 in the present modification can be made narrower than the pitch of the data lines 14 in the first embodiment. Accordingly, it is possible to cope with pitch narrowing or miniaturization.

For example, assuming that the pitch of the data lines 14 in the present modification is smaller only by about 0.2 μm than the pitch of the data lines 14 in the first embodiment, when the number of the data lines 14 is 1,920, the length of the display region 10 in the direction along the X axis can be made shorter by about 0.38 mm. This difference is larger in the micro display.

### C. Modifications

The embodiment exemplified above can variously be modified. Specific configurations of modifications applicable to the embodiment described above will be exemplified below. Two or more configurations randomly selected from the following examples can be combined as appropriate to the extent not contradictory with one another.

In the embodiment described above, the electro-optical device 100 driven in the active matrix mode is presented by way of example, but the present disclosure is not limited thereto, and the electro-optical device 100 may be driven, for example, in a passive matrix mode.

The drive system of the "electro-optical device" is not limited to a longitudinal electric field system, and may be a transverse electric field system. Note that examples of the transverse electric field system include an in-plane switching (IPS) mode. Further, examples of the longitudinal electric field system include a twisted nematic (TN) mode, a vertical alignment (VA) mode, a PVA mode, and an optically compensated bend (OCB) mode.

### 2. Electronic Apparatus

The electro-optical device 100 can be used in various electronic apparatuses.

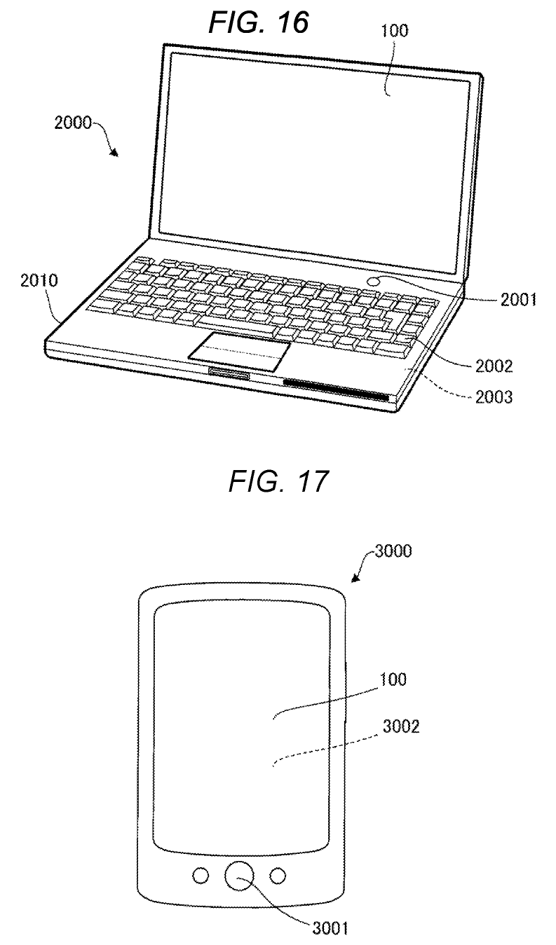

FIG. 16 is a perspective view showing a personal computer 2000 as an example of the electronic apparatus. The personal computer 2000 includes the electro-optical device 100 which displays various images, a main body 2010 provided with a power switch 2001 and a keyboard 2002, and a controller 2003. The controller 2003 includes, for example, a processor and a memory to control operations of the electro-optical device 100.

FIG. 17 is a plan view showing a smartphone 3000 as an example of the electronic apparatus. The smartphone 3000 includes an operation button 3001, the electro-optical device 100 which displays various images, and a controller 3002. The screen content displayed by the electro-optical device 100 is changed in accordance with an operation on the operation button 3001. The controller 3002 includes, for example, a processor and a memory to control the operations of the electro-optical device 100.

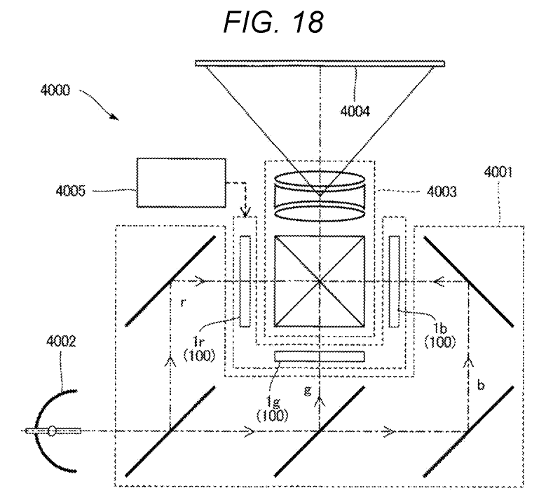

FIG. 18 is a schematic diagram showing a projector as an example of the electronic apparatus. A projection-type display apparatus 4000 is, for example, a three-panel projector. An electro-optical device 1r is the electro-optical device 100 corresponding to a red display color, an electro-optical device 1g is the electro-optical device 100 corresponding to a green display color, and an electro-optical device 1b is the electro-optical device 100 corresponding to a blue display color. That is, the projection-type display apparatus 4000 includes the three electro-optical devices 1r, 1g, and 1b corresponding respectively to the red, green, and blue display colors. A controller 4005 includes, for example, a processor and a memory to control the operations of the electro-optical devices 100.

An illumination optical system 4001 supplies the electro-optical devices 1r, 1g, and 1b respectively with a red component r, a green component g, and a blue component b of light output from an illumination device 4002 which is a light source. The electro-optical devices 1r, 1g, and 1b each functions as a light modulator such as a light valve that modulates corresponding monochromatic light supplied from the illumination optical system 4001 in accordance with an image to be displayed. A projection optical system 4003 combines the light output from the electro-optical devices 1r, 1g, and 1b with each other to project the combined light onto a projection surface 4004.

The electronic apparatuses described above each include the electro-optical device 100 described above and the controller 2003, 3002, or 4005. In the electro-optical device 100 described above, the temperature rise is suppressed. Therefore, by providing the electro-optical device 100, it is possible to improve the reliability of the personal computer 2000, the smartphone 3000, or the projection-type display device 4000.

Note that examples of the electronic apparatus in which the electro-optical device according to the present disclosure is used are not limited to the apparatuses exemplified above, but further include a personal digital assistant (PDA), a digital still camera, a television, a video camera, a car navigation system, an in-vehicle display, an electronic organizer, electronic paper, an electronic calculator, a word processor, a workstation, a video phone, and a point of sale (POS) terminal. Further, examples of the electronic apparatus to which the present disclosure is applied include a printer, a scanner, a copier, a video player, and an apparatus including a touch panel.

The present disclosure has been described above based on the preferable embodiment, but the present disclosure is not limited to the embodiment described above. In addition, the configuration of each element in the present disclosure can be replaced with any configuration that exhibits substantially the same function as that of the embodiment described above, and can be added with any configuration.

Furthermore, in the above description, the liquid crystal display device has been described as an example of the electro-optical device according to the present disclosure, but the electro-optical device according to the present disclosure is not limited thereto. For example, the electro-optical device according to the present disclosure can also be applied to an image sensor or the like.

What is claimed is:

1. An electro-optical device, comprising:
a plurality of data lines grouped every k lines, k being an integer of 2 or more;
a data signal line to which a data signal according to gray levels of pixels is output for a group of every k lines;
a transmission gate provided to correspond to each of the plurality of data lines; and
a NOT circuit provided to correspond to the transmission gate and configured to supply a selection signal to a gate node of the transmission gate, wherein
a conduction state between an input terminal and an output terminal of the transmission gate is specified based on the selection signal,
the NOT circuit includes a P-channel type transistor and an N-channel type transistor coupled in series, and
a channel length of the N-channel type transistor and a channel length of the P-channel type transistor are different from each other.

2. The electro-optical device according to claim 1, wherein
the channel length of the N-channel type transistor is longer than the channel length of the P-channel type transistor.

3. The electro-optical device according to claim 1, wherein
the channel length of the P-channel type transistor is longer than the channel length of the N-channel type transistor.

4. The electro-optical device according to claim 1, further comprising:
a substrate; and
an insulating layer disposed between the substrate and the N-channel type transistor and P-channel type transistor, wherein
a channel region of one having the longer channel length of the N-channel type transistor and the P-channel type transistor has a concave portion that is a recess toward the substrate.

5. The electro-optical device according to claim 1, further comprising:
a substrate;
an insulating layer disposed between the substrate and the N-channel type transistor and P-channel type transistor; and
a light-shielding film disposed between the substrate and the insulating layer.

6. The electro-optical device according to claim 5, wherein
the light-shielding film overlaps a gate electrode of one having the longer channel length of the N-channel type transistor and the P-channel type transistor in a plan view viewed in a thickness direction of the substrate.

7. The electro-optical device according to claim 5, further comprising:
a wire disposed above the N-channel type transistor and the P-channel type transistor, to which a constant potential is supplied; and
a contact coupling the wire and the light-shielding film.

8. The electro-optical device according to claim 1, wherein
the plurality of data lines include a first data line and a second data line,
a first NOT circuit corresponding to the first data line includes a first P-channel type transistor and a first N-channel type transistor arranged along an extension direction of the first data line,
a second NOT circuit corresponding to the second data line includes a second P-channel type transistor and a second N-channel type transistor arranged along the extension direction, and
the first P-channel type transistor and the second P-channel type transistor are arranged along a direction in which the plurality of data lines are arranged.

9. The electro-optical device according to claim 1, wherein
the plurality of data lines include a first data line and a second data line,
a first NOT circuit corresponding to the first data line includes a first P-channel type transistor and a first N-channel type transistor arranged along an extension direction of the first data line,
a second NOT circuit corresponding to the second data line includes a second P-channel type transistor and a second N-channel type transistor arranged along the extension direction, and
the first P-channel type transistor and the second N-channel type transistor are arranged along a direction in which the plurality of data lines are arranged.

10. An electronic apparatus, comprising:
the electro-optical device according to claim 1; and
a controller configured to control an operation of the electro-optical device.
